(19) United States
(12) Patent Application Publication
(10) Pub. No.: US 2009/0070153 A1
(43) Pub. Date: Mar. 12, 2009

(54) METHOD AND SYSTEM FOR ENDOWMENT INSURANCE AT AUTONOMOUS INTEREST RATES

(76) Inventors: Yung-Sung Chien, Taipei (TW); Kun Bao Ling, Taipei (TW)

Correspondence Address: SINORICA, LLC, 528 FALLSGROVE DRIVE, ROCKVILLE, MD, 20850, US

(21) Appl. No.: 12/209,413

(22) Filed: Sep. 12, 2008

(30) Foreign Application Priority Data
Sep. 12, 2007 (TW) 96133992

(51) Int. Cl. G06Q 40/00

(52) U.S. Cl. 705/4

(57) ABSTRACT

A method and a system for endowment insurance at autonomous interest rates implemented in the insurance field of financial e-commerce are provided, in which endowment insurance funds are operated in a new mode through a deposit and borrowing platform at autonomous interest rates. Thus, an insurance company can avoid bearing interest rate risks, and a consumer earns an interest of direct finance before winning a bid and has opportunities of raising funds and expanding investment after winning the bid, so as to earn higher returns than the conventional endowment insurance in a form of club deposit.

The system for endowment insurance at autonomous interest rates performs various operating procedures of the endowment insurance at autonomous interest rates, including policy purchasing, guaranty and security, funds competitive bidding for the deposit and borrowing platform at autonomous interest rates, investment management, calculation of investment profit and loss, profit sharing, and insurance money payment.

### BACKGROUND OF THE INVENTION

1. Field of Invention

The present invention relates to the insurance field of an endowment insurance in financial e-commerce, and more particularly to a method and system for endowment insurance at autonomous interest rates created by using the information technology.

2. Related Art

The endowment insurance is a conservative savings protection insurance product, also known as old-age insurance which is a savings-type insurance, in which the savings are protected during the insurance period and the premium may be withdrawn after the period expires. The interest rate of the savings part of the endowment insurance is based on a stable and safe fixed deposit interest rate, while the death benefit part disappears upon the expiration of the insurance period. In recent years, when selling an endowment insurance product, the banking industry often compares it to a combination of the club deposit and insurance, which thus wins the favor of conservative customers on the market.

In fact, the endowment insurance is a product with a fixed interest rate for which, unlike the short-term fixed deposit of the bank, the insurance company must bear the interest rate spread risk. Therefore, when the insurance company operates the “endowment insurance”, the premium must float between the amount of benefit and the interest rate spread risk. The insurance company desires to raise the amount of benefit but reduce the savings interest rate, which, however, leads to the risk of losing the market. According to the long-term observation of the insurance industry, the benefit part may be controlled profitable through precise calculation, but the interest rate spread risk is the nightmare of the insurance industry. Therefore, how to eliminate the interest rate risk has become an urgent problem of the “endowment insurance” for the insurance industry.

In recent years, with the development of information, various investment-type insurance products are developed. The conservative “endowment insurance” products increasingly cannot meet the demands for investment on the market. Even more unfortunately, the “endowment insurance” only meets the demands of conservative customers, but fails to follow the insurance trend of mass-individualization for individualized insurance products. Therefore, the insurance industry needs a customized insurance product in which special characteristics such as easy credit are brought into the “endowment insurance” to meet the demands of customer groups with various risk preferences on the market.

U.S. Pat. No. 6,999,935, entitled “Method of Calculating Premium Payment to Cover the Risk Attributable to Insureds Surviving a Specified Period”, discloses a premium calculation mechanism which pre-considers the fact that expired survival benefit received by the proposer must be taxed in order to calculate the most appropriate premium. However, this patent does not solve the problem of interest rate spread risks for the insurance company.

ROC Patent Application No. 096116081, entitled “Method and System for Constructing Online Deposit and Borrowing Platform at Autonomous Interest Rates” may be used to construct the funds operating platform of the present invention. Through the funds competitive bidding of direct finance, a proposer can earn an advantageous interest of direct finance on the deposit and borrowing platform at autonomous interest rates with the savings part of the paid premium, so as to perform self-saving, and the insurance company avoids bearing interest rate risks, and substantially reduces the possibility to get into the interest rate spread difficulty.

### SUMMARY OF THE INVENTION

Accordingly, the present invention is directed to a method and system for endowment insurance at autonomous interest rates that solve the above problems. The objectives of the present invention are as follows:

1. In the present invention, a premium is paid on a deposit and borrowing platform at autonomous interest rates, which replaces the premium structure of the conventional “endowment insurance”, such that an insurance company avoids interest rate risks, and a proposer can expand his/her credit to make investment so as to gain higher returns.

2. In the present invention, a concept of an insurance platform is established to rid the insurance company of the superstition that “no risk, no return” and to enable the insurance company to earn the commission fee under information symmetry.

3. In the present invention, an insurance platform of an interactive transaction concept is established. Conventional insurance contracts are set by the insurance company through precise calculation. The precise calculation result is not transparent, and allows no intervention of the consumer. In the network era, due to the developed information technology, an equal, reasonable, and highly transparent interactive insurance platform is realized.

4. The present invention provides the proposer with a right of deciding the fee payment, such that the proposer may freely select not to bid to obtain savings protection, or to bid to obtain funds so as to make investment with higher profits and participate in profit sharing of the insurance company to increase a total amount of insurance money that may be obtained in the future.

5. The present invention is the savings-type insurance combining savings and protection, which eliminates moral risks, such that the proposer and a beneficiary can obtain protection for the future through the savings or investment.

6. The present invention is an open insurance product, which is different from the conventional “endowment insurance” product that is suitable for only conservative customers, and can meet the demands of investor groups with various risk preferences.

7. In the present invention, the market interest rate can be reflected through the operation of the deposit and borrowing platform at autonomous interest rates, so as to set a representative reference interest rate on the market.

To achieve the above objectives, the present invention provides a method for endowment insurance at autonomous interest rates, which is applied in a system for endowment insurance at autonomous interest rates. The method includes the following steps:

A proposer enters the system for endowment insurance at autonomous interest rates with an electronic certificate. An online policy purchasing operation module of the system for endowment insurance at autonomous interest rates obtains basic information of the proposer corresponding to the electronic certificate from an electronic certificate issuing institution and verifies the basic information. The proposer purchases an endowment insurance policy at autonomous interest rates provided by the online policy purchasing operation module.

The proposer logs in to the system for endowment insurance at autonomous interest rates, and enters a bidding amount to participate in a competitive bidding. A deposit and borrowing platform competitive bidding module at autonomous interest rates of the system for endowment insurance at autonomous interest rates calculates an average deposit interest rate and a borrowing interest rate of the bidding proposer according to the entered bidding amount, and determines a successful bidding amount and a number of successful bidders according to a fund balance of the deposit and borrowing platform competitive bidding module at autonomous interest rates and the borrowing interest rate of the bidding proposer.

An insurance money payment operation module of the system for endowment insurance at autonomous interest rates clears a total successful bidding amount and a repayment amount according to the successful bidding amount, and clears a deposit amount according to the average borrowing interest rate and a deposit bid bond of the successful bidding proposer, a highest bidding amount of the unsuccessful bidding proposer, or a benchmark interest rate.

The insurance money payment operation module settles a deposit amount that has been deposited in a personal virtual account of the unsuccessful bidding proposer.

When the proposer does not win the bid, the insurance money payment operation module determines whether an accident happens to an insurant before the endowment insurance policy at autonomous interest rates expires.

When the proposer does not win the bid, the insurance money payment operation module pays endowment insurance proceeds of the endowment insurance policy at autonomous interest rates to a beneficiary if an accident happens to the insurant before the endowment insurance policy at autonomous interest rates expires.

The insurance money payment operation module settles the repayment amount of the successful bidding proposer.

The insurance money payment operation module settles the total successful bidding amount to deposit it in an investment management account of the proposer that wins the bid in the current session.

An investment management operation module of the system for endowment insurance at autonomous interest rates provides various investment objectives for the proposer to make an investment of the total successful bidding amount of the investment management account, and publishes an investment objective, an investment profit and loss, and a net asset value corresponding to the investment of the total successful bidding amount.

When the proposer wins the bid, the insurance money payment operation module determines whether the endowment insurance policy at autonomous interest rates expires.

If the endowment insurance policy at autonomous interest rates expires, the insurance money payment operation module clears the net asset value gained through the investment of the total successful bidding amount of the investment management account of the proposer, and clears a bonus generated after the endowment insurance payment is deducted from the net asset value.

When the bonus is positive, the insurance money payment operation module pays the endowment insurance payment and the bonus to the proposer. When the bonus is negative or zero, the insurance money payment operation module pays the endowment insurance payment to the proposer.

If the endowment insurance policy at autonomous interest rates does not expire, the insurance money payment operation module determines whether an accident happens to the insurant when the proposer wins the bid.

When the proposer wins the bid, the insurance money payment operation module clears the net asset value gained through the investment of the total successful bidding amount of the investment management account of the proposer, and clears the bonus generated after the endowment insurance proceeds are deducted from the net asset value if an accident happens to the insurant.

When the bonus is positive, the insurance money payment operation module pays the endowment insurance proceeds and the bonus to the beneficiary. When the bonus is negative or zero, the insurance money payment operation module pays the endowment insurance proceeds to the beneficiary.

The present invention provides a system for endowment insurance at autonomous interest rates, including an online policy purchasing operation module, an autonomous platform competitive bidding module, an investment management operation module, and an insurance money payment operation module.

The online policy purchasing operation module is used to obtain basic information of a proposer from an external electronic certificate issuing institution of the system for endowment insurance at autonomous interest rates according to an electronic certificate of the proposer, verify the basic information, and provide an endowment insurance policy at autonomous interest rates for the proposer to select to purchase.

The autonomous platform competitive bidding module is used to enter a bidding amount to calculate an average deposit interest rate and a borrowing interest rate by the proposer, and determine a successful bidding amount and a number of successful bidders according to a fund balance of the deposit and borrowing platform competitive bidding module at autonomous interest rates and the borrowing interest rate.

The investment management operation module is used to provide various investment objectives for the proposer to make an investment of a total successful bidding amount of an investment management account, and publish an investment objective, an investment profit and loss, and a net asset value corresponding to the investment of the total successful bidding amount of the investment management account.

The insurance money payment operation module is used to clear the total successful bidding amount and a repayment amount according to the successful bidding amount, clear a deposit amount according to the average borrowing interest rate and a deposit bid bond, a highest bidding amount, or a benchmark interest rate, settle and deposit the total successful bidding amount in the investment management account, settle the deposit amount that has been deposited in the personal virtual account, and settle the repayment amount paid at each session, and pay endowment insurance proceeds or an endowment insurance payment and/or a bonus to the proposer or a beneficiary according to whether the endowment insurance policy at autonomous interest rates expires and whether an accident happens to an insurant. The bonus is a positive balance after the endowment insurance proceeds or the endowment insurance payment are/is deducted from the net asset value gained through the investment of the total successful bidding amount.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a system for endowment insurance at autonomous interest rates of the present invention; and

FIG. 2 is a flow chart of a method for endowment insurance at autonomous interest rates of the present invention.

### DETAILED DESCRIPTION OF THE INVENTION

In order to make the present invention practicable, preferred embodiments will be described in detail below.

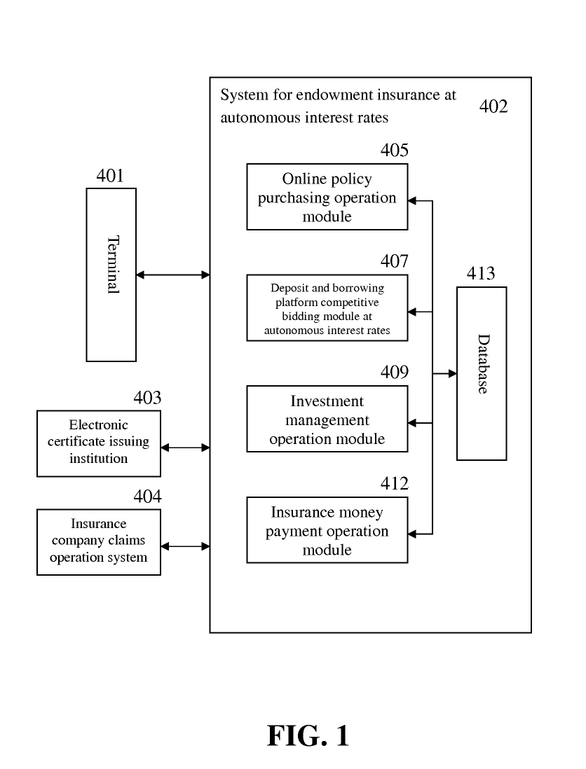

FIG. 1 is a block diagram of a system for endowment insurance at autonomous interest rates of the present invention. In FIG. 1, the system 402 for endowment insurance at autonomous interest rates communicates with an external terminal 401 (for example, a computer, a mobile phone, or a PDA) of the system 402 for endowment insurance at autonomous interest rates used by a proposer through a network and in a wired and wireless communication mode, so as to perform a real-time and safe message exchange with the proposer. The proposer purchases an endowment insurance policy at autonomous interest rates from the system 402 for endowment insurance at autonomous interest rates, participates in a competitive bidding of the system 402 for endowment insurance at autonomous interest rates, and knows a competitive bidding result and the receiving and payment amount from the system 402 for endowment insurance at autonomous interest rates through the terminal 401.

The following describes the operation of each module such as an online policy purchasing operation module 405, a deposit and borrowing platform competitive bidding module 407 at autonomous interest rates, an investment management operation module 409, an insurance money payment operation module 412, and a database 413 included in the system 402 for endowment insurance at autonomous interest rates.

The online policy purchasing operation module 405 obtains basic information of the proposer from an external electronic certificate issuing institution 403 of the system 402 for endowment insurance at autonomous interest rates according to an electronic certificate of the proposer, verifies the basic information of the proposer, and provides an endowment insurance policy at autonomous interest rates for the proposer to select to purchase.

After the insurance money payment operation module 412 collects a premium paid by the proposer, the online policy purchasing operation module 405 issues an electronic policy of the endowment insurance policy at autonomous interest rates to the proposer.

Underwriting items of the electronic policy include whether the content of a proposal form is complete and true, a qualification of the proposer to purchase the endowment insurance policy at autonomous interest rates, a relation between the proposer and an insurant, a qualification of the insurant to be covered, whether an insurance contract receives a written approval from the insurant, a total contribution amount of a competitive bidding transaction combination of the endowment insurance policy at autonomous interest rates participated by the proposer, a proportion between an actual economic demand and a sum insured of the insurant, and whether the proposer can continually and stably pay the premium for a long term according to the personal condition, employment situation, and annual income of the proposer.

The electronic certificate issuing institution 403 receives information of the endowment insurance policy at autonomous interest rates transferred by an insurance company, and transfers the endowment insurance policy at autonomous interest rates to the insurance company after encryption, digital signature, and storage. Then, the insurance company transfers the endowment insurance policy at autonomous interest rates to the proposer.

The endowment insurance policy at autonomous interest rates includes the competitive bidding transaction combination, including a competitive bidding time limit, a number of competitive bidding sessions, and a total contribution amount. An amount of endowment insurance proceeds (in the case of an accident) or an endowment insurance payment (in the case of no accident when the time limit expires) of the endowment insurance policy at autonomous interest rates is equal to that of the total contribution amount of the competitive bidding transaction combination.

The proposer enters a bidding amount into the deposit and borrowing platform competitive bidding module 407 at autonomous interest rates through the terminal 401, so as to calculate an average deposit interest rate and a borrowing interest rate according to all the entered bidding amounts, and to determine a successful bidding amount and a number of successful bidders according to a fund balance calculated by the deposit and borrowing platform competitive bidding module 407 at autonomous interest rates in the current session and the previous session and the borrowing interest rates.

The investment management operation module 409 provides various investment objectives for the proposer to make an investment of a total successful bidding amount of an investment management account, and publishes an investment objective, an investment profit and loss, and a net asset value corresponding to the investment of the total successful bidding amount of the investment management account. The investment objective includes a financial product of at least one of a common fund, securities, and a financial derivative product.

The insurance money payment operation module 412 clears the total successful bidding amount and a repayment amount according to the successful bidding amount, and clears a deposit amount according to the average borrowing interest rate and a deposit bid bond, a highest bidding amount, or a benchmark interest rate. The insurance money payment operation module 412 settles the total successful bidding amount to be deposited in the investment management account, the deposit amount that has been deposited in a personal virtual account, and the repayment amount to be paid at each session.

The insurance money payment operation module 412 pays endowment insurance proceeds (in the case of an accident) or an endowment insurance payment (in the case of no accident when the policy expires) and/or a bonus to the proposer or a beneficiary according to whether the endowment insurance policy at autonomous interest rates expires and whether any accident happens to the insurant. The bonus is a positive balance after the endowment insurance proceeds are deducted from the net asset value gained through the investment of the total successful bidding amount.

The insurance money payment operation module 412 respectively converts the deposit amount of the unsuccessful bidding proposer and the repayment amount of the successful bidding proposers into a part of the total successful bidding amount of the proposers that win the bid in the session.

The insurance money payment operation module 412 receives a claim application result transferred by an external insurance company claims operation system 404 of the system 402 for endowment insurance at autonomous interest rates. When an accident happens to the insurant, the insurance company accepts a claim application, carries out an insurance accident identification, and determines whether the claim application conforms to the claim standard, so as to obtain the claim application result.

The database 413 is used by the online policy purchasing operation module 405 to access the basic information of the proposer, the information of the endowment insurance policy at autonomous interest rates and the competitive bidding transaction combination, used by the deposit and borrowing platform competitive bidding module 407 at autonomous interest rates to access the information of the bidding amount, the average deposit interest rate, the borrowing interest rate, the fund balance, the successful bidding amount, and the number of the successful bidders, used by the investment management operation module 409 to access the information of the investment objective, the investment profit and loss, and the net asset value, and used by the insurance money payment operation module 412 to access the information of the successful bidding amount, the total successful bidding amount, the average borrowing interest rate, the deposit bid bond, the repayment amount, the highest bidding amount, the benchmark interest rate, the deposit amount, accident information of the insurant, the endowment insurance proceeds or the endowment insurance payment, the bonus, the endowment insurance policy at autonomous interest rates, the investment management account, and the personal virtual account.

A deposit and borrowing method at autonomous interest rates with the characteristic of direct finance is mainly constructed on the basis of a concept of fund balance. The deposit and borrowing platform competitive bidding module 407 at autonomous interest rates of the system 402 for endowment insurance at autonomous interest rates calculates corresponding borrowing interest rates according to bidding amounts of all bidders (i.e., proposers), and determines the number of people who win the bid, the total successful bidding amount that all successful bidders (the proposers) can obtain, and the amount that unsuccessful bidders (herein depositors and also proposers) should deposit at each time point (i.e., a bid opening time) according to the fund balance and the borrowing interest rates. The process is as follows:

Step 1: let the number of successful bidders be zero, and the deposit and borrowing platform competitive bidding module 407 at autonomous interest rates calculates a fund balance at this time point. The deposit and borrowing platform competitive bidding module 407 at autonomous interest rates calculates the fund balance by subtracting the total successful bidding amount of all successful bidders at this time point from the amount that all unsuccessful bidders should deposit at this time point. Only a total deposit amount of all depositors and the amount required to be deposited by the unsuccessful bidders need to be calculated in this step. The calculation is performed with the following two formulas based on whether the interest is pre-paid or post-paid:

In the case of pre-paid interest:

U−IXₙ (1)

In the case of post-paid interest:

U (2)

where,

U is a competitive bidding upper limit of the bidder; and

IXₙ is a deposit bid bond of the depositor calculated according to a benchmark interest rate in the n^{th} session.

In addition, the total successful bidding amount of the successful bidders (the borrowers) is calculated with the following two formulas based on whether the interest is pre-paid or post-paid:

In the case of pre-paid interest:

Aₙ=(U−Iₙ)×(N−n)+U×(n−1) (3)

In the case of post-paid interest:

$${A}_{n} = U \times ( N - n ) + U \times ( n - 1 ) + {\sum }_{i = j}^{n - j} {I}_{i} \qquad ( 4 )$$

where,

Aₙ is the total successful bidding amount of the successful bidders when the bid is won in the n^{th} session;

U is a competitive bidding upper limit;

N is a number of competitive bidding sessions;

n is a current session, and n≦N

Iₙ is the successful bidding amount in the n^{th} session of the successful bidder; and

Iᵢ is the amount that the depositor deposits in the i^{th} session, and i<n.

The pre-paid interest refers to that the interest to be paid in the future has been deducted from the obtained principal in advance at borrowing, which is similar to the zero coupon bond. The post-paid interest refers to that complete principal can be obtained at borrowing and the interest will be paid in the future when making repayments, which is similar to the common loan or house loan.

Step 2: the deposit and borrowing platform competitive bidding module 407 at autonomous interest rates determines whether a fund balance X at a previous time point+a fund balance B₀ at this time point (i.e., a fund level) is less than or equal to zero. If the fund balance X at the previous time point plus the fund balance B₀ at this time point is less than or equal to zero (i.e., B₀+X≦0), the deposit and borrowing platform competitive bidding module 407 at autonomous interest rates determines not to open the bid at this time point. On the contrary, if the deposit and borrowing platform competitive bidding module 407 at autonomous interest rates determines that the fund balance is greater than zero, the flow proceeds to Step 3.

When a deposit and borrowing mechanism at autonomous interest rates similar to the direct finance is constructed, the fund balance in the deposit and borrowing platform competitive bidding module 407 at autonomous interest rates should be equal to zero. However, the probability that the fund balance in the deposit and borrowing platform competitive bidding module 407 at autonomous interest rates is exactly equal to zero is very small. If the fund balance in the deposit and borrowing platform competitive bidding module 407 at autonomous interest rates is greater than zero, for a financial institution operating this method, the form of the fund balance becomes a borrowing amount of the financial institution, resulting in an outlay cost of the financial institution. If the fund balance in the deposit and borrowing platform competitive bidding module 407 at autonomous interest rates is smaller than zero, for the financial institution operating this method, the form of the fund balance becomes a lending amount of the financial institution, and the financial institution can earn a small amount of commission fee, thereby changing the conventional operating mode of indirect finance in which the financial institution earns a spread between the deposit interest rate and the loan interest rate. Here, in the deposit and borrowing method at autonomous interest rates, it is assumed that the fund balance in the deposit and borrowing platform competitive bidding module 407 at autonomous interest rates is smaller than or equal to zero in the operation of the competitive bidding transaction.

Step 3: the borrowing interest rates are sorted. If the fund balance calculated by the deposit and borrowing platform competitive bidding module 407 at autonomous interest rates in Step 2 is greater than zero, the deposit and borrowing platform competitive bidding module 407 at autonomous interest rates calculates corresponding borrowing interest rates for the bidding amounts of bidders who place bids, and sorts the borrowing interest rates. When a borrowing interest rate of bid bond in the n^{th} (n falls at this time point for calculation) session of a bidder is calculated, the deposit and borrowing platform competitive bidding module 407 at autonomous interest rates first uses the following formula (5) to calculate an average deposit interest rate r of previous sessions of the bidder, and then uses the following formula (6) to calculate a borrowing interest rate R if the bidder wins the bid at the time point, for example, by using a financial concept of internal rate of return (IRR). The formulas are as follows:

$$\begin{matrix}{\sum }_{i = I}^{n - 1} ( U - {I}_{i} ) \times {( 1 + r )}^{N - i} = U \times ( n - 1 ) & ( 5 ) \\ {\sum }_{i = I}^{n - 1} ( U - {I}_{i} ) \times {( 1 + r )}^{n - i} + {\sum }_{j = 1}^{N - n} U \times {( \frac{1}{1 + R} )}^{j} = {A}_{n} & ( 6 )\end{matrix}$$

where,

U is a competitive bidding upper limit;

N is a number of competitive bidding sessions;

n is a current session, and n≦N;

Iᵢ is the amount that the depositor deposits in the i^{th} session, and i<n;

r is the average deposit interest rate from the 1^{st} to the i^{th} session of the depositor;

R is the borrowing interest rate; and

Aₙ is the total successful bidding amount of the successful bidders if the bid is won in the n^{th} session, and is calculated with reference to formulas (3) and (4).

The deposit and borrowing platform competitive bidding module 407 at autonomous interest rates sorts the borrowing interest rates corresponding to all bidders from high to low immediately after calculating the borrowing interest rates of all bidders at this time point.

Step 4: the deposit and borrowing platform competitive bidding module 407 at autonomous interest rates finds a maximum number of successful bidders making the fund balance approach zero. In this step, for example, a concept of trial and error method is used to find the number of the successful bidders n when the fund balance at this time point plus the fund balance at a previous time point of the deposit and borrowing platform competitive bidding module 407 at autonomous interest rates is smaller than or equal to zero, and then, a minimum number of bidders who win the bid is found:

Min {n|Bₙ+X≦0} (7)

where,

Bₙ is the fund balance when the number of the successful bidders at this time point is n; and

X is the fund balance at the previous time point.

Step 5: the successful bidders are cleared. For the successful bidders (borrowers), the insurance money payment operation module 412 calculates the total successful bidding amount of the successful bidders in the situation that the bid is won at this time point. The calculation of the insurance money payment operation module 412 is performed with the following two formulas based on whether the interest is pre-paid or post-paid:

In the case of pre-paid interest:

Aₙ=(U−Iₙ)×(N−n)+U×(n−1) (8)

In the case of post-paid interest:

$${A}_{n} = U \times ( N - n ) + U \times ( n - 1 ) + {\sum }_{i = j}^{n - j} {I}_{i} \qquad ( 9 )$$

where,

Aₙ is the total successful bidding amount of the successful bidders when the bid is won in the n^{th} session;

U is a competitive bidding upper limit;

N is a number of competitive bidding sessions;

n is a current session, and n≦N;

Iₙ is the successful bidding amount in the n^{th} session of the successful bidder; and

Iᵢ is the amount that the depositor deposits in the i^{th} session, and i<n.

The successful bidder needs to make repayments in the future sessions, and a repayment amount is calculated according to the following formulas:

In the case of pre-paid interest:

U (10)

In the case of post-paid interest:

U+Iₙ (11)

where,

U is a competitive bidding upper limit; and

Iₙ is the amount that the bidder bids in the n^{th} session.

Step 6: the users who do not win the bid are cleared. When the deposit and borrowing platform competitive bidding module 407 at autonomous interest rates determines that the number of people that may win the bid at this time point is n (n=1 . . . I), the insurance money payment operation module 412 clears an average borrowing interest rate when the number of bidders who may win the bid at this time point is n, and then calculates a deposit amount IAₙ of an unsuccessful bidder (i.e., a depositor). The insurance money payment operation module 412 clears the deposit amount IAₙ of the depositors with the following two formulas based on whether the interest is pre-paid or post-paid:

In the case of pre-paid interest:

(U−IAₙ)×(1+Rₐ)^{N-n}=U (12)

In the case of post-paid interest:

U×(1+Rₐ)^{N-n}=U+IAₙ (13)

where,

U is a competitive bidding upper limit;

N is a number of competitive bidding sessions;

n is a current session, and n≦N

IAₙ is the deposit amount of the depositor calculated according to the average borrowing interest rate of the n^{th} session; and

Rₐ is an average borrowing interest rate.

If a bidder wins the bid at this time point, the insurance money payment operation module 412 calculates the deposit amount IAₙ according to the average borrowing interest rate. The amount to be deposited by the unsuccessful bidder is similarly calculated with the following two formulas based on whether the interest is pre-paid or post-paid:

In the case of pre-paid interest:

U−IAₙ (14)

In the case of post-paid interest:

U (15)

where,

U is a competitive bidding upper limit; and

IAₙ is the deposit amount of the depositor calculated according to the average borrowing interest rate of the n^{th} session.

If no bidder wins the bid, but the bidder places a bid at this time point (the bidder must deposit money because he/she does not win the bid), the insurance money payment operation module 412 calculates the deposit amount of the bidder with the following two formulas based on whether the interest is pre-paid or post-paid:

In the case of pre-paid interest:

U−IHₙ (16)

In the case of post-paid interest:

U (17)

where,

U is a competitive bidding upper limit; and

IHₙ is a highest bidding amount of the bidder who does not win the bid in the n^{th} session.

As for the unsuccessful bidder, if no bidder wins the bid and the bidder does not place any bid in the n^{th} session, the insurance money payment operation module 412 calculates the deposit amount of the bidder with the following two formulas based on whether the interest is pre-paid or post-paid:

In the case of pre-paid interest:

U−IXₙ (18)

In the case of post-paid interest:

U (19)

where,

U is a competitive bidding upper limit; and

IXₙ is the deposit amount of the depositor calculated according to a benchmark interest rate of the n^{th} session.

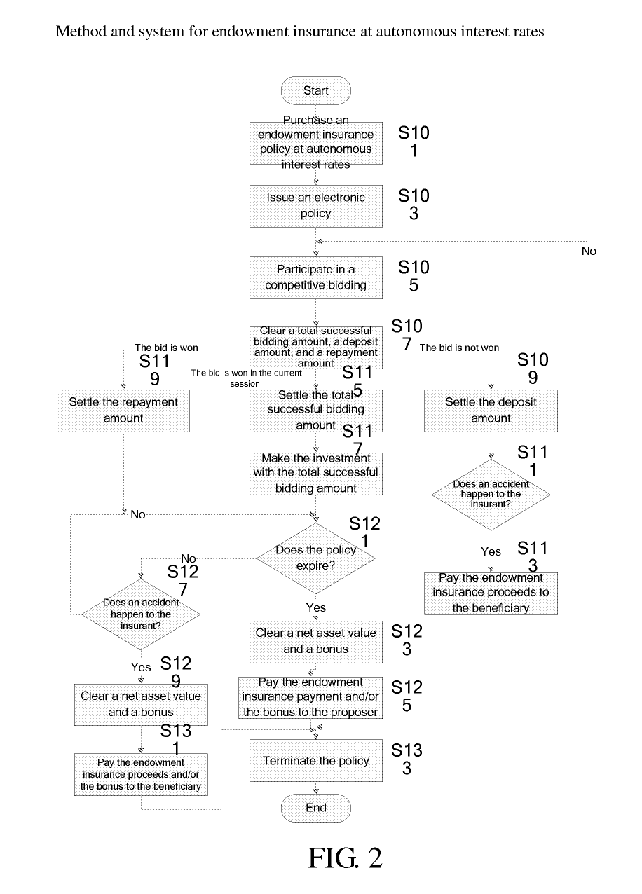

FIG. 2 is a flow chart of a method for endowment insurance at autonomous interest rates of the present invention. The flow of FIG. 2 is described with reference to the components in FIG. 1.

First, the proposer logs in to the system 402 for endowment insurance at autonomous interest rates with an electronic certificate through the terminal 401. The online policy purchasing operation module 405 of the system 402 for endowment insurance at autonomous interest rates obtains basic information of the proposer corresponding to the electronic certificate from the electronic certificate issuing institution 403, and verifies the basic information. The online policy purchasing operation module 405 provides various forms of endowment insurance policies at autonomous interest rates for the proposer to select to purchase (Step S101). The online policy purchasing operation module 405 stores the basic information of the proposer, the mutual-aid endowment insurance policy and the like in the database 413.

The endowment insurance policy at autonomous interest rates includes a competitive bidding transaction combination including a competitive bidding time limit, a number of competitive bidding sessions, and a total contribution amount. An amount of endowment insurance proceeds (in the case of an accident) or an endowment insurance payment (in the case of no accident when the time limit expires) of the endowment insurance policy at autonomous interest rates is equal to that of the total contribution amount of the competitive bidding transaction combination.

The electronic certificate of the proposer is an electronic certificate issued by the electronic certificate issuing institution 403 to the proposer after the basic information is provided by the proposer to the electronic certificate issuing institution 403 and is verified upon an application to the electronic certificate issuing institution 403.

The insurance money payment operation module 412 collects a premium of the endowment insurance policy at autonomous interest rates paid by the proposer, and the online policy purchasing operation module 405 issues an electronic policy of the endowment insurance policy at autonomous interest rates to the proposer (Step S103). Underwriting items of the electronic policy are as described above.

Fees to be paid according to the provisions of the endowment insurance policy at autonomous interest rates include the premium in the insurance period and a deposit amount or repayment amount in a competitive bidding period of the system 402 for endowment insurance at autonomous interest rates.

The proposer enters the system 402 for endowment insurance at autonomous interest rates and enters a bidding amount through the terminal 401 to participate in the competitive bidding. The deposit and borrowing platform competitive bidding module 407 at autonomous interest rates calculates an average deposit interest rate and a borrowing interest rate of all bidding proposers based on the description of Step 3 of the deposit and borrowing method at autonomous interest rates according to the entered bidding amounts. In Steps 1-4 of the deposit and borrowing method at autonomous interest rates, a successful bidding amount and a number of successful bidders are determined according to a fund balance of the deposit and borrowing platform competitive bidding module 407 at autonomous interest rates and the borrowing interest rate of the bidding proposer (Step S105). The deposit and borrowing platform competitive bidding module 407 at autonomous interest rates stores the information in the database 413.

In Step 5 of the deposit and borrowing method at autonomous interest rates, the insurance money payment operation module 412 clears a total successful bidding amount and a repayment amount of the successful bidding proposers according to the successful bidding amount. In Step 6 of the deposit and borrowing method at autonomous interest rates, the insurance money payment operation module 412 clears a deposit amount of unsuccessful bidding proposers according to the average borrowing interest rate of the successful bidding proposers and a deposit bid bond of the unsuccessful bidding proposers, a highest bidding amount of the unsuccessful bidding proposers, or a benchmark interest rate (Step S107). The insurance money payment operation module 412 stores the information in the database 413.

The insurance money payment operation module 412 converts the deposit amount of the unsuccessful bidding proposers into a part of the total successful bidding amount of the proposers who win the bid in the session, and converts the repayment amount of the successful bidding proposers into a part of the total successful bidding amount of the proposers who win the bid in the session.

Then, the insurance money payment operation module 412 settles the deposit amount that has been deposited in a personal virtual account of an unsuccessful bidding proposer (Step S109). When the proposer does not win the bid, the insurance money payment operation module 412 determines whether an accident happens to an insurant before the endowment insurance policy at autonomous interest rates expires (Step S111). When an accident happens to the insurant, an insurance company accepts a claim application, carries out an insurance accident identification, and determines whether the claim conforms to the claim standard. The insurance company transfers a claim application result to the insurance money payment operation module 412 of the system 402 for endowment insurance at autonomous interest rates through the insurance company claims operation system 404.

When the proposer does not win the bid, the insurance money payment operation module 412 pays endowment insurance proceeds of the endowment insurance policy at autonomous interest rates to a beneficiary (Step S113) if an accident happens to the insurant before the endowment insurance policy at autonomous interest rates expires. When the proposer does not win the bid, the flow proceeds to Step S105 if no accident happens to the insurant before the endowment insurance policy at autonomous interest rates expires.

Next, the insurance money payment operation module 412 settles the total successful bidding amount, and deposits it in an investment management account of a proposer who wins the bid in the current session (Step S115). The investment management operation module 409 provides various investment objectives for the proposer to make an investment of the total successful bidding amount of the investment management account, and publishes an investment objective, an investment profit and loss, and a net asset value corresponding to the investment of the total successful bidding amount. The investment management operation module 409 stores the information in the database 413 (Step S117). Afterwards, the insurance money payment operation module 412 settles the repayment amount of the successful bidding proposers (Step S119). The investment objective includes a financial product of at least one of a common fund, securities, and a financial derivative product.

When the proposer has won the bid, the insurance money payment operation module 412 determines whether the endowment insurance policy at autonomous interest rates expires (Step S121). When the endowment insurance policy at autonomous interest rates expires, the insurance company notifies the insurance money payment operation module 412 through the insurance company claims operation system 404.

If the endowment insurance policy at autonomous interest rates expires, the insurance money payment operation module 412 clears a net asset value gained through the investment of the total successful bidding amount of the investment management account of the proposer, and clears a bonus generated after the endowment insurance payment is deducted from the net asset value (Step S123).

When the bonus is positive, the insurance money payment operation module 412 pays the endowment insurance payment and the bonus to the proposer. When the bonus is negative or zero, the insurance money payment operation module 412 pays the endowment insurance payment to the proposer (Step S125).

If the endowment insurance policy at autonomous interest rates does not expire, the insurance money payment operation module 412 determines whether an accident happens to the insurant (Step S127) when the proposer has won the bid. The method for determining whether an accident happens to the insurant is as described in Step S111.

When the proposer has won the bid, the flow proceeds to Step S121 if no accident happens to the insurant; or the insurance money payment operation module 412 clears a net asset value gained through the investment of the total successful bidding amount of the investment management account of the proposer, and clears a bonus generated after the endowment insurance payment is deducted from the net asset value (Step S129) if an accident happens to the insurant.

When the bonus is positive, the insurance money payment operation module 412 pays the endowment insurance payment and the bonus to the beneficiary. When the bonus is negative or zero, the insurance money payment operation module 412 pays the endowment insurance payment to the beneficiary (Step S131).

When the beneficiary or the proposer receives the endowment insurance payment and/or the bonus, a contract of the endowment insurance policy at autonomous interest rates is terminated (Step S133).

An embodiment is illustrated below with reference to FIGS. 1 and 2, in which the implementation of the method and system for endowment insurance at autonomous interest rates of the present invention is illustrated.

For example, Tom is Jerry's father. Tom wants to purchase an insurance product of the endowment insurance at autonomous interest rates provided in the present invention. Therefore, Tom performs a purchasing operation of an endowment insurance policy at autonomous interest rates on the system 402 for endowment insurance at autonomous interest rates on line through the terminal 401 (Step S101). The mutual-aid endowment insurance policy includes a competitive bidding transaction combination having a competitive bidding time limit, a number of competitive bidding sessions, and a total contribution amount.

After the policy purchasing operation module 405 verifies basic information of Tom and Tom pays a premium, the online policy purchasing operation module 405 issues an electronic policy of the endowment insurance policy at autonomous interest rates (Step S103). An insurance contract of an endowment insurance policy at autonomous interest rates that Tom selects to purchase after an underwriting of an insurance company is as follows.

Endowment Insurance Policy at Autonomous Interest Rates

```
    Policy Conditions [symbol]
  Proposer: Tom [symbol]
  Insurant: Tom [symbol]
  Beneficiary: Jerry (son of Tom) [symbol]
  Insurance period: 6 years [symbol]
  Insurance money: NT$720,000, excluding savings income and bonus [symbol]
  Bonus standard: The proposer can gain 90% profits of the bonus
    investment. [symbol]
  Premium: NT$500/month plus savings or contribution amount
    The proposer of this policy can operate on the deposit and borrowing
platform at autonomous interest rates of the insurance company under
the following conditions: [symbol]
  Period: a total of 73 sessions for 6 years (1 session/month) [symbol]
  Contribution amount: NT$10,000 [symbol]
  Bottom price: calculated based on the two-year period flexible interest
    rate of Postal Savings in a floating mode
```

Tom obtains the guarantee of endowment insurance and an opportunity for savings or raising funds to expand investment upon purchase of this policy. It is assumed that Tom performs savings in the competitive bidding period (i.e., Tom does not win the bid and pays a deposit amount cleared by the insurance money payment operation module 412 in the competitive bidding period) (Steps S105, S107, and S109). If the insurance money payment operation module 412 determines that an accident event (i.e., a claim event such as death or total disability) happens to Tom (Step S111) before the endowment insurance policy at autonomous interest rates expires, the beneficiary, Jerry can obtain endowment insurance proceeds of NT$720,000 paid by the insurance money payment operation module 412 (Step S113) no matter how many sessions for which Tom has paid the premium and the deposit amount. Afterwards, the contract of the endowment insurance policy at autonomous interest rates is terminated (Step S133).

After the savings of Tom are due (i.e., Tom wins the bid naturally in the last session) (Steps S105 and S107), the insurance money payment operation module 412 settles the deposit amounts of all sessions plus interests (i.e., the total successful bidding amount in Step 5 of the deposit and borrowing method at autonomous interest rates), and deposit the money in an investment management account of Tom (Step S115).

Since no accident happens to Tom when the endowment insurance policy at autonomous interest rates expires (Step S121), Tom can obtain an endowment insurance payment of NT$720,000 (Steps S123 and S125), which is based on the claim payment principle of the endowment insurance at autonomous interest rates. Afterwards, the contract of the endowment insurance policy at autonomous interest rates is terminated (Step S133).

Here, it is assumed that Tom performs savings and does not compete for a bid in first two years of the competitive bidding period (Step S105), and the deposit and borrowing platform competitive bidding module 407 at autonomous interest rates calculates, for example, an average bid bond of NT$1,000 in all the sessions (Step S107). That is, in addition to the premium of NT$500 paid in previous 24 sessions, Tom needs to pay a deposit amount of NT$9,000 (10,000−1,000) (as described in Step 6 of the deposit and borrowing method at autonomous interest rates) into his personal virtual account in each session to perform the savings (Step S109).

If Tom participates in the competitive bidding on the system 402 for endowment insurance at autonomous interest rates at the beginning of the third year (i.e., in the 25^{th} session), and the deposit and borrowing platform competitive bidding module 407 at autonomous interest rates determines that Tom wins the bid with a bid bond of NT$1,200 (Step S105), the insurance money payment operation module 412 clears a total successful bidding amount of NT$662,400 (8,800*48+10,000*24) that Tom can obtain (as described in Step 5 of the deposit and borrowing method at autonomous interest rates) (Step S115). The investment management operation module 409 provides various investment objectives for Tom to select, and the investment is made according to an investment objective selected by Tom based on the total successful bidding amount (Step S117). Then, Tom has to repay a repayment amount of NT$10,000 in each of sessions after he wins the bid (as described in Step 5 of the deposit and borrowing method at autonomous interest rates).

Something unexpected may happen any time. If Tom dies unfortunately in the third year after he purchases the endowment insurance policy at autonomous interest rates (Step S127), Jerry (the beneficiary) may request the insurance company to settle an insurance claim. The insurance company notifies the insurance money payment operation module 412 of a claim application result through the insurance company claims operation system 404. The insurance money payment operation module 412 clears a net asset value gained through the investment of the total successful bidding amount of Tom. It is assumed that the investment in this year has a good performance with a rate of return of 10%. The insurance money payment operation module 412 clears a bonus generated after the endowment insurance proceeds are deducted from the net asset value (Step S129). According to the conditions in the endowment insurance policy at autonomous interest rates, as the beneficiary, Jerry will obtain the 90% profit of the investment income, i.e., obtain the bonus of NT$7,776 ((662,400*110%−720,000)*90%). Therefore, the insurance money payment operation module 412 pays a sum of NT$727,776 including the endowment insurance proceeds of NT$720,000 and the bonus of NT$7,776 to Jerry (Step S131). Thus, Jerry can obtain a guarantee higher NT$720,000 because Tom gave up the conventional endowment insurance and chose the endowment insurance at autonomous interest rates. Afterwards, the contract of the endowment insurance policy at autonomous interest rates is terminated (Step S133).

In addition, if Tom has no accident in the insurance time limit of 6 years and stably obtains the annual rate of return of 10% in the four years during which the investment is made, when the policy ends, the insurance money payment operation module 412 needs to pay a sum of NT$944,838 (720,000+[662,400*(1+10%)̂4−720,000]*90%) including the endowment insurance proceeds and the bonus to Tom after clearing his net asset value and bonus (Step S123). Therefore, the endowment insurance at autonomous interest rates provided by the present invention can provide a better guarantee than the conventional endowment insurance.

Although the present invention has been described above with reference to the preferred embodiment and illustrative drawings, they should not be regarded as limitations to the present invention. It will be apparent to those skilled in the art that various modifications, omissions, and variations can be made to the form and contents of the embodiment of the present invention without departing from the scope or spirit of the invention. In view of the foregoing, it is intended that the present invention covers modifications, omissions, and variations of this invention provided they fall within the scope of the following claims and their equivalents.

What is claimed is:

1. A method for endowment insurance at autonomous interest rates, applied in a system for endowment insurance at autonomous interest rates, comprising:
a proposer logging in to the system for endowment insurance at autonomous interest rates with an electronic certificate, an online policy purchasing operation module of the system for endowment insurance at autonomous interest rates obtaining basic information of the proposer corresponding to the electronic certificate from an electronic certificate issuing institution, and verifying the basic information, and the proposer purchasing an endowment insurance policy at autonomous interest rates provided by the online policy purchasing operation module;
the proposer logging in to the system for endowment insurance at autonomous interest rates and entering a bidding amount to participate in a competitive bidding, a deposit and borrowing platform competitive bidding module at autonomous interest rates of the system for endowment insurance at autonomous interest rates calculating an average deposit interest rate and a borrowing interest rate of the bidding proposer according to the entered bidding amount, and determining a successful bidding amount and a number of successful bidders according to a fund balance of the deposit and borrowing platform competitive bidding module at autonomous interest rates and the borrowing interest rates of the bidding proposer;
an insurance money payment operation module of the system for endowment insurance at autonomous interest rates clearing a total successful bidding amount and a repayment amount according to the successful bidding amount, and clearing a deposit amount according to the average borrowing interest rate and a deposit bid bond of the successful bidding proposer, a highest bidding amount of the unsuccessful bidding proposer, or a benchmark interest rate;
the insurance money payment operation module settling the deposit amount that has been deposited in a personal virtual account of the unsuccessful bidding proposer;
when the proposer does not win the bid, the insurance money payment operation module determining whether an accident happens to an insurant before the endowment insurance policy at autonomous interest rates expires;
when the proposer does not win the bid, the insurance money payment operation module paying endowment insurance proceeds of the endowment insurance policy at autonomous interest rates to a beneficiary if an accident happens to the insurant before the endowment insurance policy at autonomous interest rates expires;
the insurance money payment operation module settling the repayment amount of the successful bidding proposer;
the insurance money payment operation module settling and depositing the total successful bidding amount in an investment management account of the proposer who wins the bid in a current session;
an investment management operation module of the system for endowment insurance at autonomous interest rates providing various investment objectives for the proposer to make an investment of the total successful bidding amount of the investment management account, and publishing an investment objective, an investment profit and loss, and a net asset value corresponding to the investment of the total successful bidding amount;
when the proposer has won the bid, the insurance money payment operation module determining whether the endowment insurance policy at autonomous interest rates expires;
if the endowment insurance policy at autonomous interest rates expires, the insurance money payment operation module clearing the net asset value gained through the investment of the total successful bidding amount of the investment management account of the proposer, and clearing a bonus generated after the endowment insurance payment is deducted from the net asset value;
when the bonus is positive, the insurance money payment operation module paying the endowment insurance payment and the bonus to the proposer; when the bonus is negative or zero, the insurance money payment operation module paying the endowment insurance payment to the proposer;
if the endowment insurance policy at autonomous interest rates does not expire, the insurance money payment operation module determining whether an accident happens to the insurant when the proposer has won the bid;
when the proposer has won the bid, the insurance money payment operation module clearing the net asset value gained through the investment of the total successful bidding amount of the investment management account of the proposer and clearing the bonus generated after the endowment insurance proceeds are deducted from the net asset value if an accident happens to the insurant; and
when the bonus is positive, the insurance money payment operation module paying the endowment insurance proceeds and the bonus to the beneficiary; when the bonus is negative or zero, the insurance money payment operation module paying the endowment insurance proceeds to the beneficiary.

2. The method according to claim 1, further comprising:
the insurance money payment operation module collecting a premium paid by the proposer, and the online policy purchasing operation module issuing an electronic policy of the endowment insurance policy at autonomous interest rates to the proposer;
when the proposer does not win the bid, performing the step of the proposer logging in to the system for endowment insurance at autonomous interest rates and entering the bidding amount to participate in the competitive bidding if no accident happens to the insurant;
when the proposer has won the bid, performing the step of the insurance money payment operation module determining whether the endowment insurance policy at autonomous interest rates expires if no accident happens to the insurant; and
when the beneficiary or the proposer receives the endowment insurance payment and/or the bonus, terminating a contract of the endowment insurance policy at autonomous interest rates.

3. The method according to claim 2, wherein underwriting items of the electronic policy comprise whether contents of a proposal form are complete and true, a qualification of the proposer, a relation between the proposer and an insurant, a qualification of the insurant, whether the insurance contract receives a written approval from the insurant, a total contribution amount of a competitive bidding transaction combination of the endowment insurance policy at autonomous interest rates participated by the proposer, a proportion between an actual economic demand and a sum insured of the insurant, and whether the proposer can continually and stably pay the premium for a long term according to a personal condition, an employment situation, and an annual income of the proposer.

4. The method according to claim 1, wherein the system for endowment insurance at autonomous interest rates communicates with a terminal through a network and in a wired and wireless communication mode, so as to perform a real-time and safe message exchange with the proposer.

5. The method according to claim 1, wherein an amount of the endowment insurance proceeds or the endowment insurance payment of the endowment insurance policy at autonomous interest rates is equal to that of a total contribution amount of a competitive bidding transaction combination of the endowment insurance policy at autonomous interest rates.

6. The method according to claim 5, wherein the competitive bidding transaction combination comprises a competitive bidding time limit, a number of competitive bidding sessions, and the total contribution amount.

7. The method according to claim 1, wherein the investment objective comprises a financial product of at least one of a common fund, securities, and a financial derivative product.

8. The method according to claim 1, wherein
the deposit and borrowing platform competitive bidding module at autonomous interest rates calculates an amount that all unsuccessful bidding proposers should deposit at a bid opening time point minus a total successful bidding amount of all successful bidding proposers at this time point, and stores the total successful bidding amount in a database of the system for endowment insurance at autonomous interest rates;
the deposit and borrowing platform competitive bidding module at autonomous interest rates determines whether the fund balance at a previous bid opening time point plus the fund balance at this bid opening time point is smaller than or equal to zero, and stores the calculated fund balance in the database;
the deposit and borrowing platform competitive bidding module at autonomous interest rates calculates the borrowing interest rates according to the bidding amount of the bidding proposer and a total contribution amount of a competitive bidding transaction combination of the endowment insurance policy at autonomous interest rates read out from the database, sorts the borrowing interest rates of all the bidding proposers, and stores the borrowing interest rates in the database; and
the deposit and borrowing platform competitive bidding module at autonomous interest rates determines the successful bidding amount and the number of the successful bidders according to the fund balance and the borrowing interest rates of the bidding proposers read out from the database, and stores the successful bidding amount and the number of the successful bidders in the database.

9. The method according to claim 1, wherein
the insurance money payment operation module converts the deposit amount of the unsuccessful bidding proposers into a part of the total successful bidding amount of the proposers who win the bid in the session; and
the insurance money payment operation module converts the repayment amount of the successful bidding proposers into a part of the total successful bidding amount of the proposers who win the bid in the session.

10. The method according to claim 1, wherein an insurance company transfers information of the endowment insurance policy at autonomous interest rates to the electronic certificate issuing institution, after an encryption, digital signature, and storage, the electronic certificate issuing institution transfers the endowment insurance policy at autonomous interest rates to the insurance company, and then, the insurance company transfers the endowment insurance policy at autonomous interest rates to the proposer.

11. The method according to claim 1, wherein the insurance money payment operation module receives a claim application result transferred by an external insurance company claims operation system of the system for endowment insurance at autonomous interest rates, and the claim application result is generated by an insurance company after receiving a claim application, carrying out an insurance accident identification, and determining whether the claim conforms to a claim standard upon an accident to the insurant.

12. A system for endowment insurance at autonomous interest rates, comprising:
an online policy purchasing operation module, for obtaining basic information of a proposer from an external electronic certificate issuing institution of the system for endowment insurance at autonomous interest rates according to an electronic certificate of the proposer, verifying the basic information, and providing an endowment insurance policy at autonomous interest rates for the proposer to select to purchase;
a deposit and borrowing platform competitive bidding module at autonomous interest rates, for the proposer to enter a bidding amount to calculate an average deposit interest rate and a borrowing interest rate, and to determine a successful bidding amount and a number of successful bidders according to a fund balance of the deposit and borrowing platform competitive bidding module at autonomous interest rates and the borrowing interest rate;
an investment management operation module, for providing various investment objectives for the proposer to make an investment of a total successful bidding amount of an investment management account, and publishing an investment objective, an investment profit and loss, and a net asset value corresponding to the investment of the total successful bidding amount of the investment management account; and
an insurance money payment operation module, for clearing the total successful bidding amount and a repayment amount according to the successful bidding amount, clearing a deposit amount according to the average borrowing interest rate and a deposit bid bond, a highest bidding amount, or a benchmark interest rate, settling and depositing the total successful bidding amount in the investment management account, settling the deposit amount that has been deposited in a personal virtual account, and settling the repayment amount paid at each session, and paying endowment insurance proceeds or an endowment insurance payment and/or a bonus to the proposer or a beneficiary according to whether the endowment insurance policy at autonomous interest rates expires and whether an accident happens to an insurant, wherein the bonus is a positive balance generated after the endowment insurance proceeds or the endowment insurance payment are/is deducted from the net asset value gained through the investment of the total successful bidding amount.

13. The system for endowment insurance at autonomous interest rates according to claim 12, further comprising:
the online policy purchasing operation module, for the insurance money payment operation module to collect a premium paid by the proposer, so as to issue an electronic policy of the endowment insurance policy at autonomous interest rates to the proposer; and
a database, for the online policy purchasing operation module to access the basic information of the proposer, information of the endowment insurance policy at autonomous interest rates, for the deposit and borrowing platform competitive bidding module at autonomous interest rates to access information of the bidding amount, the average deposit interest rate, the borrowing interest rate, the fund balance, the successful bidding amount, and the number of the successful bidders, for the investment management operation module to access information of the investment objective, the investment profit and loss, and the net asset value, and for the insurance money payment operation module to access information of the successful bidding amount, the total successful bidding amount, the average borrowing interest rate, the deposit bid bond, the repayment amount, the highest bidding amount, the benchmark interest rate, the deposit amount, accident information of the insurant, the endowment insurance proceeds, the insurance payment, the bonus, the endowment insurance policy at autonomous interest rates, the investment management account, and the personal virtual account.

14. The system for endowment insurance at autonomous interest rates according to claim 13, wherein underwriting items of the electronic policy comprise whether contents of a proposal form are complete and true, a qualification of the proposer, a relation between the proposer and an insurant, a qualification of the insurant, whether the insurance contract receives a written approval from the insurant, a total contribution amount of a competitive bidding transaction combination of the endowment insurance policy at autonomous interest rates participated by the proposer, a proportion between an actual economic demand and a sum insured of the insurant, and whether the proposer can continually and stably pay the premium for a long term according to a personal condition, an employment situation, and an annual income of the proposer.

15. The system for endowment insurance at autonomous interest rates according to claim 12, wherein the system for endowment insurance at autonomous interest rates communicates with a terminal through a network and in a wired and wireless communication mode, so as to perform a real-time and safe message exchange with the proposer.

16. The system for endowment insurance at autonomous interest rates according to claim 12, wherein the electronic certificate issuing institution receives information of the endowment insurance policy at autonomous interest rates transferred by an insurance company, and transfers the endowment insurance policy at autonomous interest rates to the insurance company after an encryption, digital signature, and storage, and then, the insurance company transfers the endowment insurance policy at autonomous interest rates to the proposer.

17. The system for endowment insurance at autonomous interest rates according to claim 12, wherein the insurance money payment operation module receives a claim application result transferred by an external insurance company claims operation system of the system for endowment insurance at autonomous interest rates, and the claim application result is generated by an insurance company after receiving a claim application, carrying out an insurance accident identification, and determining whether the claim conforms to a claim standard upon an accident to the insurant.

18. The system for endowment insurance at autonomous interest rates according to claim 12, wherein an amount of the endowment insurance proceeds or the endowment insurance payment of the endowment insurance policy at autonomous interest rates is equal to that of a total contribution amount of a competitive bidding transaction combination of the endowment insurance policy at autonomous interest rates.

19. The system for endowment insurance at autonomous interest rates according to claim 18, wherein the competitive bidding transaction combination comprises a competitive bidding time limit, a number of competitive bidding sessions, and the total contribution amount.

20. The system for endowment insurance at autonomous interest rates according to claim 12, wherein the investment objective comprises a financial product of at least one of a common fund, securities, and a financial derivative product.

21. The system for endowment insurance at autonomous interest rates according to claim 12, wherein the deposit and borrowing platform competitive bidding module at autonomous interest rates performs the following steps:
calculating an amount that all unsuccessful bidding proposers should deposit at a bid opening time point minus a total successful bidding amount of all successful bidding proposers at this time point, and storing the total successful bidding amount in a database of the system for endowment insurance at autonomous interest rates;
determining whether the fund balance at a previous bid opening time point plus the fund balance at this bid opening time point is smaller than or equal to zero, and storing the calculated fund balance in the database;
calculating the borrowing interest rates according to the bidding amount of the bidding proposer and a total contribution amount of a competitive bidding transaction combination of the endowment insurance policy at autonomous interest rates read out from the database, sorting the borrowing interest rates of all the bidding proposers, and storing the borrowing interest rates in the database; and
determining the successful bidding amount and the number of the successful bidders according to the fund balance and the borrowing interest rates of the bidding proposers read out from the database, and storing the successful bidding amount and the number of the successful bidders in the database.

22. The system for endowment insurance at autonomous interest rates according to claim 12, wherein the insurance money payment operation module respectively converts the deposit amount of the unsuccessful bidding proposers and the repayment amount of the successful bidding proposers into a part of the total successful bidding amount of the proposers who win the bid in the session.
